(19) United States
(12) Patent Application Publication
(10) Pub. No.: US 2006/0058067 A1
(43) Pub. Date: Mar. 16, 2006

(54) System and method for transmitting data between a base station and a mobile unit using frequency-diverse carriers

(76) Inventor: Nagi A. Mansour, Arlington, VA (US)

Correspondence Address: CROWELL & MORING LLP;INTELLECTUAL PROPERTY GROUP, P.O. BOX 14300, WASHINGTON, DC, 20044-4300, US

(21) Appl. No.: 11/189,504

(22) Filed: Jul. 26, 2005

Related U.S. Application Data
(60) Provisional application No. 60/608,911, filed on Sep. 13, 2004.

(51) Int. Cl. H04B 1/38

(52) U.S. Cl. 455/561

(57) ABSTRACT

A wireless communication system including a base transceiver station (BTS) adapted to transmit data to a mobile unit (MU) during a communication session by way of a first set of different frequency carriers. The BTS may send the data to the MU using CDMA modulation. The BTS may also receive data from the MU during the same communication session by way of a second set of different frequency carriers. In processing the received data, the BTS may detect a loss of data associated with at least one of the second set of different frequency carriers, and attempt to recover the lost data. If the received data is out of order, the BTS may rearrange the data in a predetermined manner. If the received data is modulated in a CDMA manner, the BTS may perform the demodulation thereof. The BTS may be adapted to send the data to a network device.

### CROSS-REFERENCE TO A RELATED APPLICATION

This application claims the benefit of the filing date of Provisional Application, Ser. No. 60/608,911, filed on Sep. 13, 2004, and entitled “System and Method for Transmitting User Data Bits in a CDMA Network,” which is herein incorporated by reference.

### FIELD OF THE INVENTION

This invention relates generally to wireless communication systems, and in particular, to a system and method for transmitting data between a base station and a mobile communication unit (MU) using frequency-diverse carriers.

### BACKGROUND OF THE INVENTION

Conventional wireless communication systems typically include a network consisting of a plurality of network devices, and a plurality of base transceiver stations (BTS) to allow the network to communicate with a plurality of mobile communication units (MU) by way of a wireless medium. Typically, in such convention wireless communication systems, the communication between a base transceiver station (BTS) and a mobile communication unit (MU) during a particular session is conducted using a single radio frequency (RF) carrier. A drawback of using a single RF carrier is that if fading occurs during the communication session, there is a potential for significant data loss. This is explained in more detail below with reference to the following example.

FIG. 1A illustrates a block diagram of an exemplary conventional wireless communication system 100. The conventional wireless communication system 100 consists of a network 102 and a plurality of base transceiver stations (BTS 1, 2, and 3) 104, 106, and 108 coupled to the network 102. Base transceiver station (BTS 1) 104 is assigned to communicate with a plurality of mobile communication units (MU) 111 through 130 via the wireless medium. Similarly, base transceiver station (BTS 2) 106 is assigned to communicate with a plurality of mobile communication units (MU) 131 through 150 via the wireless medium. And likewise, base transceiver station (BTS 3) 108 is assigned to communicate with a plurality of mobile communication units (MU) 151 through 170 via the wireless medium. As discussed above, each base transceiver station (BTS) communicates with one of the mobile communication unit (MU) using a single RF carrier. This is further elaborated below.

FIG. 1B illustrates a diagram depicting the data transmission scheme implemented in the exemplary conventional wireless communication system 100. Such a data transmission scheme is currently proposed in wireless CDMA protocols such as 1×EV-DV and 1×EV-DO. For instance, in this example, base transceiver station (BTS 1) 104 communicates with mobile communication units (MU) 111 through 130 using a first RF carrier 1 in the forward link. Similarly, base transceiver station (BTS 2) 106 communicates with mobile communication units (MU) 131 through 135 using a second RF carrier 2 in the forward link. And, likewise, base transceiver station (BTS 3) 104 communicates with mobile communication units (MU) 151 through 170 using a third RF carrier 3 in the forward link.

Such a data transmission scheme is susceptible to data loss due to fading and/or multipath conditions. For instance, assume mobile communication unit (MU) 111, during a communication session with base station transceiver (BTS 1) 104, moves to a location where substantial amount of fading occurs in the transmission between base station transceiver (BTS 1) 104 and mobile communication unit (MU) 111. During the fading event, there is a relatively high likelihood that data transmitted between the base station transceiver (BTS 1) 104 and the mobile communication unit (MU) 111 will be lost.

### SUMMARY OF THE INVENTION

An aspect of the invention relates to a wireless communication system, comprising a base transceiver station (BTS) adapted to transmit data to a mobile communication unit (MU) during a communication session by way of a set of different frequency carriers. The base transceiver station (BTS) may be further adapted to modulate the data in a code division multiple access (CDMA) manner. The use of multiple, different frequency carriers reduces the risk of data loss due to fading, multipath, and/or other adverse RF environment conditions.

Another aspect of the invention relates to a base transceiver station (BTS), comprising an antenna; a processor adapted to generate and/or receive first data to send to a mobile communication unit (MU); a radio frequency (RF) interface adapted to modulate the data onto a set of different frequency carriers, and transmit the set of different frequency carriers to the mobile communication unit (MU) by way of the antenna.

Another aspect of the invention relates to a wireless communication system, comprising a base transceiver station (BTS) adapted to receive data from a mobile communication unit (MU) during a communication session by way of a set of different frequency carriers. The base transceiver station (BTS) may be further adapted to detect a loss of data carried by at least one of the different frequency carriers; and attempt to recover the lost data by, for example, an error correction technique. The base transceiver station (BTS) may be further adapted to rearrange the data received from the mobile communication unit (MU) in a predetermined manner. Additionally, the base transceiver station (BTS) may be further adapted to perform code division multiple access (CDMA) demodulation to obtain the data received from the mobile communication unit (MU). Further, the base transceiver station (BTS) may be adapted to send the data received from the mobile communication unit (MU) to a network device.

Another aspect of the invention relates to a base transceiver station (BTS), comprising an antenna; a processor; and an RF interface adapted to demodulate a set of different frequency carriers received from a mobile communication unit (MU) during a communication session by way of the antenna to obtain data, and send the data to the processor. The processor may be further adapted to detect a loss of some of the data associated with at least one of the different frequency carriers, and attempt to recover the lost data by, for example, an error correction technique. The processor may be further adapted to rearrange the data in a predetermined manner. Additionally, the processor may be adapted to perform code division multiple access (CDMA) demodulation to obtain the data. Further, the processor may be adapted to send the data to a network device by way of a network interface.

Another aspect of the invention relates to a mobile communication unit (MU), comprising an antenna; a radio frequency (RF) interface adapted to demodulate a first set of different frequency carriers received by way of the antenna to obtain data from a base transceiver station (BTS); and a processor adapted to receive the data from the base transceiver station (BTS). The processor may be further adapted to detect a loss of data carried by at least one of the different frequency carriers; and attempt to recover the lost data by, for example, an error correction technique. The processor may be further adapted to rearrange the data received from the base transceiver station (BTS) in a predetermined order. Additionally, the processor may be further adapted to perform code division multiple access (CDMA) demodulation to obtain the data. Further, the processor may be adapted to send the data to an output device.

Another aspect of the invention relates to a mobile communication unit (MU), comprising an antenna; a processor adapted to generate and/or receive data for transmission to a base transceiver station (BTS); a radio frequency (RF) interface adapted to modulate the data onto a set of different frequency carriers, and transmit the different frequency carriers to the base transceiver station (BTS) by way of the antenna. The processor may be further adapted to code division multiple access (CDMA) modulate the data. Additionally, the mobile communication unit (MU) may include an input device adapted to generate and send the data to the processor.

Other aspects, features, and techniques of the invention will be apparent to one skilled in the relevant art in view of the following detailed description of the exemplary embodiments of the invention.

### BRIEF DESCRIPTION OF THE DRAWINGS

FIG. 1A illustrates a block diagram of an exemplary, conventional wireless communication system;

FIG. 1B illustrates a diagram depicting the data transmission scheme implemented in the exemplary, conventional wireless communication system;

FIG. 2A illustrates a block diagram of an exemplary wireless communication system in accordance with an embodiment of the invention;

FIG. 2B illustrates a diagram depicting an exemplary data transmission scheme implemented in the exemplary wireless communication system in accordance with another embodiment of the invention;

FIG. 3A illustrates a block diagram of an exemplary base transceiver station (BTS) in accordance with another embodiment of the invention;

FIG. 3B illustrates a flow diagram of an exemplary method of transmitting data to a mobile communication unit (MU) in accordance with another embodiment of the invention;

FIG. 3C illustrates a flow diagram of an exemplary method of receiving data from a mobile communication unit (MU) in accordance with another embodiment of the invention;

FIG. 4A illustrates a block diagram of an exemplary mobile communication unit (MU) in accordance with another embodiment of the invention;

FIG. 4B illustrates a flow diagram of an exemplary method of transmitting data to a base transceiver station (BTS) in accordance with another embodiment of the invention; and

FIG. 4C illustrates a flow diagram of an exemplary method of receiving data from a base transceiver station (BTS) in accordance with another embodiment of the invention.

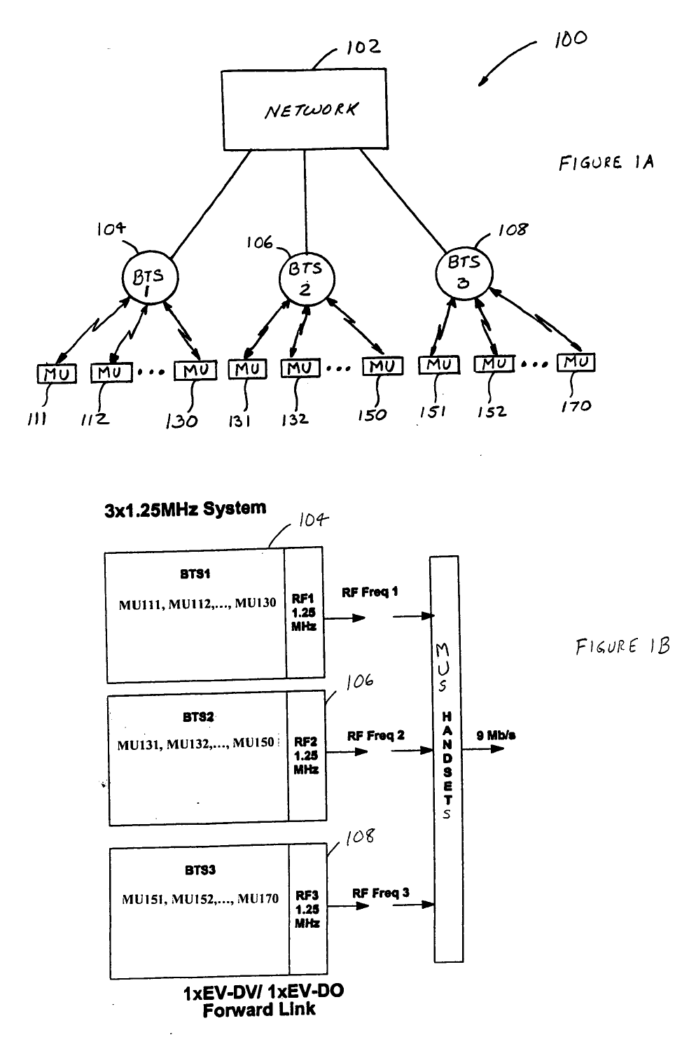

### DESCRIPTION OF THE EXEMPLARY EMBODIMENTS

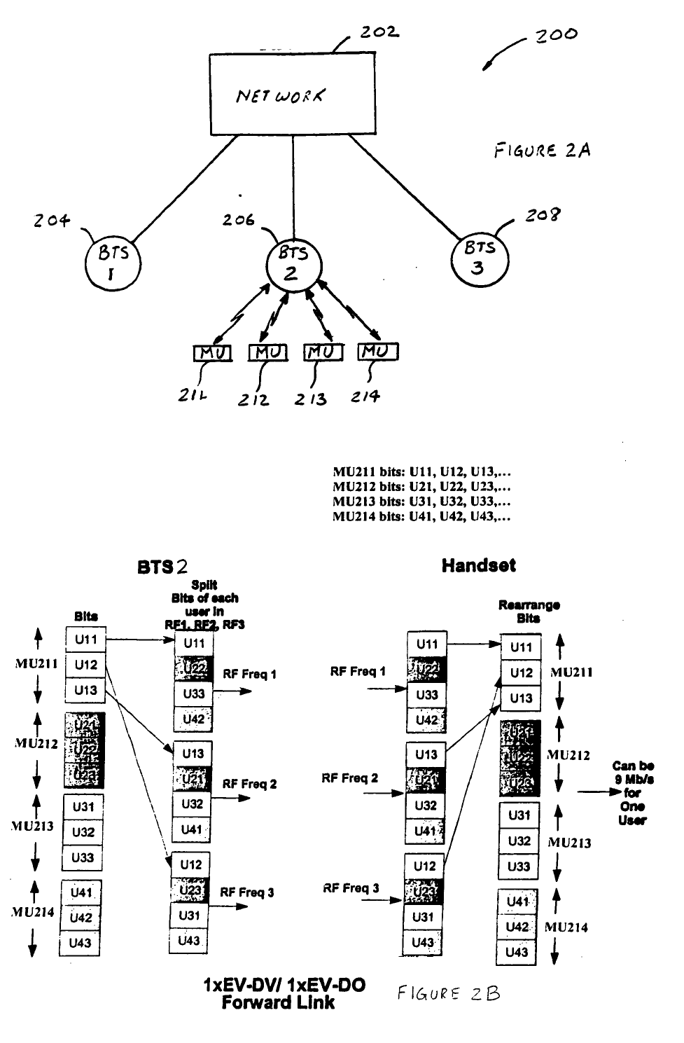

FIG. 2A illustrates a block diagram of an exemplary wireless communication system 200 in accordance with an embodiment of the invention.

The wireless communication system 200 comprises a network 202 and a plurality of base transceiver stations (BTS), three of which are shown as base transceiver stations (BTS 1, 2, and 3) 204, 206, and 208. In this example, base station transceiver (BTS 2) 206 communicates with a plurality of mobile communication units (MU) 211 through 214. Although not shown, it shall be understood that the other base transceiver stations (BTS 1 and 3) 204 and 208 also communicate with other mobile communication units (MU). As discussed in more detail below, in the exemplary wireless communication system 200, the data transmission during a communication session between a base transceiver station (BTS) and a mobile communication unit (MU) uses multiple different RF carriers to reduce the likelihood of data loss due to poor RF environment conditions, and to improve the likelihood of the reconstruction of the lost data, if any.

FIG. 2B illustrates a diagram depicting an exemplary data transmission scheme implemented in the exemplary wireless communication system 200 in accordance with another embodiment of the invention. The data transmission scheme may be used in systems that use the 1×EV-DV CDMA 2000 protocol, 1×EV-DO CDMA 2000 protocol, and others. According to the data transmission scheme, the base transceiver station (BTS 2) 206 multiplexes the data stream for a mobile communication unit (MU) among a plurality of different RF carriers. For example, bits U11, U12, and U13 of the data stream for MU 211 are multiplexed onto three different RF carriers 1, 2, and 3, respectively. Similarly, bits U21, U22, and U23 of the data stream for MU 212 are multiplexed onto three different RF carriers 2, 1, and 3, respectively. Likewise, bits U31, U32, and U33 of the data stream for MU 213 are multiplexed onto three different RF carriers 3, 2, and 1, respectively. And, in a similar manner, bits U41, U42, and U43 of the data stream for MU 214 are multiplexed onto three different RF carriers 2, 1, and 3, respectively.

Thus, according to this data transmission scheme, the base transceiver station (BTS 2) transmit respective portions (U11, U22, U33, and U42) of the data stream for mobile communication units (MU) 211, 212, 213, and 214 using RF carrier 1; respective portions (U13, U21, U32, and U41) of the data stream for mobile communication units (MU) 211, 212, 213, and 214 using RF carrier 2; and respective portions (U12, U23, U31, and U43) of the data stream for mobile communication units (MU) 211, 212, 213, and 214 using RF carrier 3.

Each mobile communication unit (MU) receives the different RF carriers, selects its own data from the data streams carried by the different RF carriers, and arranges the data in the appropriate sequential order. For example, mobile communication unit (MU) 211 receives RF carriers 1, 2, and 3, selects its own data U11, U12, and U13 respectively from the RF carriers 1, 2, and 3, and rearranges the data in sequential order U11, U12, and U13. Similarly, mobile communication unit (MU) 212 receives RF carriers 1, 2, and 3, selects its own data U22, U21, and U23 from the RF carriers 1, 2, and 3, and rearranges the data in sequential order U21, U22, and U23. Likewise, mobile communication unit (MU) 213 receives RF carriers 1, 2, and 3, selects its own data U33, U32, and U31 from the RF carriers 1, 2, and 3, and rearranges the data in sequential order U31, U32, and U33. And, in a similar manner, mobile communication unit (MU) 214 receives RF carriers 1, 2, and 3, selects its own data U42, U41, and U43 from the RF carriers 1, 2, and 3, and rearranges the data in sequential order U41, U42, and U43.

An advantage of the data transmission scheme of the wireless communication system 200 is that the data transmission is less susceptible to data loss due to poor RF environment effects, such as fading and multipath. For example, assume that mobile communication unit (MU) 211 is in an RF environment where fading and/or multipath is affecting its reception of only RF carrier 2. In such a case, the mobile communication unit (MU) 211 only receives data carried by RF carriers 1 and 3. That is, the mobile communication unit (MU) 211 receives data U11 and U13. The mobile communication unit (MU) 211 may now use an error correction technique to recover the lost data U12. Whereas in the conventional wireless communication system 100, a poor RF environment adversely affecting the only RF carrier used to communicate with base transceiver station (BTS 2) 206 and mobile communication unit (MU) 211 would likely result in the loss of the entire data stream U11, U12, and U13, which most likely would not be recoverable.

Although in this example, the data transmission scheme was discussed with reference to the forward link (i.e., the data being transmitted from a base transceiver station (BTS) to a mobile communication unit (MU)), it shall be understood that such data transmission scheme may also be implemented in the reverse link (i.e., the data being transmitted from a mobile communication unit (MU) to a base transceiver station (BTS)). That is, the mobile communication unit (MU) transmits data to the base transceiver station (BTS) using multiple different frequency carriers.

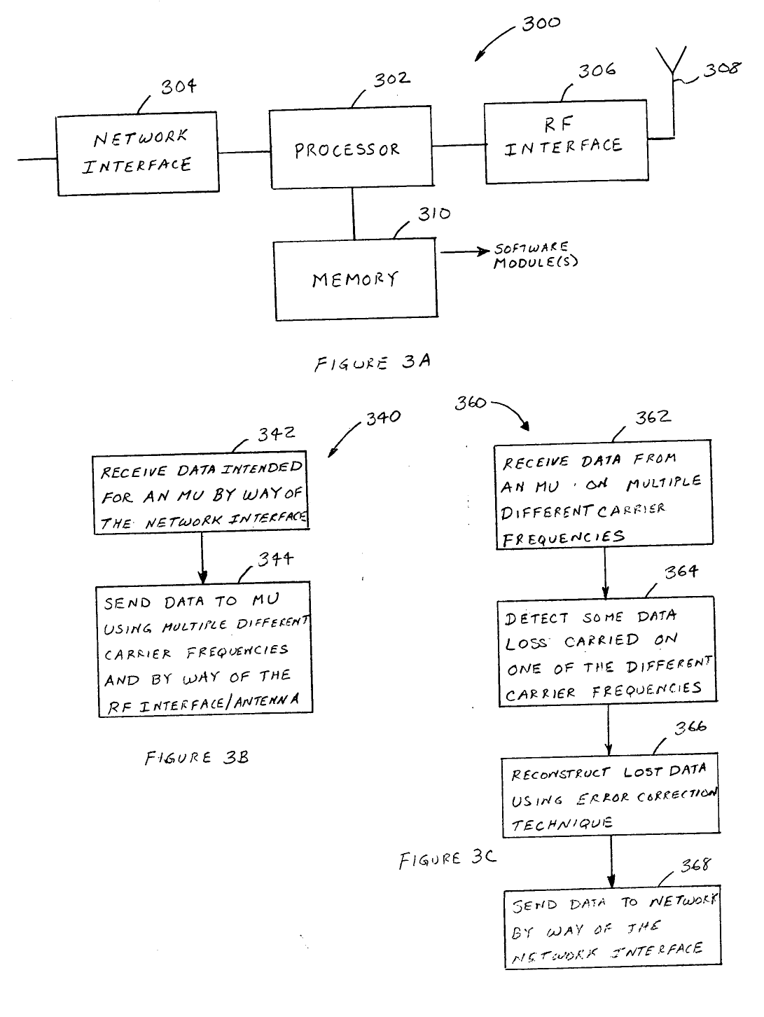

FIG. 3A illustrates a block diagram of an exemplary base transceiver station (BTS) 300 in accordance with another embodiment of the invention. The base transceiver station (BTS) 300 may be an exemplary detailed version of any one of the base transceiver stations (BTS 1, 2, and 3) 204, 206, and 208 of the wireless communication system 200. In particular, the base transceiver station (BTS) 300 comprises a processor 302, an RF interface 306 and antenna 308, a network interface 304, and a memory 310. The processor 302 assists in performing the various operations of the base transceiver station (BTS) 300, two of which are described with reference to FIGS. 3B and 3C. The RF interface 306 and antenna 308 provide the processor 302 an interface to the wireless medium for communicating with mobile communication units (MU). The network interface 304 provides the processor an interface to communicate with network devices. And the memory 310, serving generally as a computer readable medium, stores one or more software module(s) for controlling the operations of the processor 302.

FIG. 3B illustrates a flow diagram of an exemplary method 340 of transmitting data to a mobile communication unit (MU) in accordance with another embodiment of the invention. According to the method 340, the processor 302 receives data intended for the mobile communication unit (MU) from a network device by way of the network interface 304 (block 342). For example, the data intended for the mobile communication unit (MU) may come from a network device such as a dispatch call controller, a mobile switching center (MSC), or a media server. Alternatively, or in addition to, the processor 302 may generate its own data for transmission to the mobile communication unit (MU).

If the corresponding wireless communication system uses code division multiple access (CDMA), the processor 302 may modulate the data in a CDMA manner. Once the processor 302 has obtained the data and modulated in a CDMA manner, it sends the data to the RF interface 306 for transmission to the mobile communication unit (MU) (block 344). The RF interface 306 modulates the CDMA data onto multiple, different RF carriers, and then transmits the RF carriers to the mobile communication unit (MU) by way of the antenna 308.

FIG. 3C illustrates a flow diagram of an exemplary method 360 of receiving data from a mobile communication unit (MU) in accordance with another embodiment of the invention. According to the method 360, the processor 302 receives data intended for a network device from the mobile communication unit (MU) by way of the RF interface 306 and antenna 308 (block 362). The data received was originally modulated onto multiple, different RF carriers and subsequently demodulated by the RF interface 306. The processor 302 may then perform CDMA demodulation to obtain the raw data. In this example, the processor 302 detects that some data associated with at least one of the RF carriers has been lost (block 364). This may have been as a result of a poor RF environment for that particular RF carrier. The processor 302 then performs an error correction technique to recover the lost data (block 366). Once the lost data has been recovered, the processor 302 may send the data to a target network device by way of the network interface 304 (block 368).

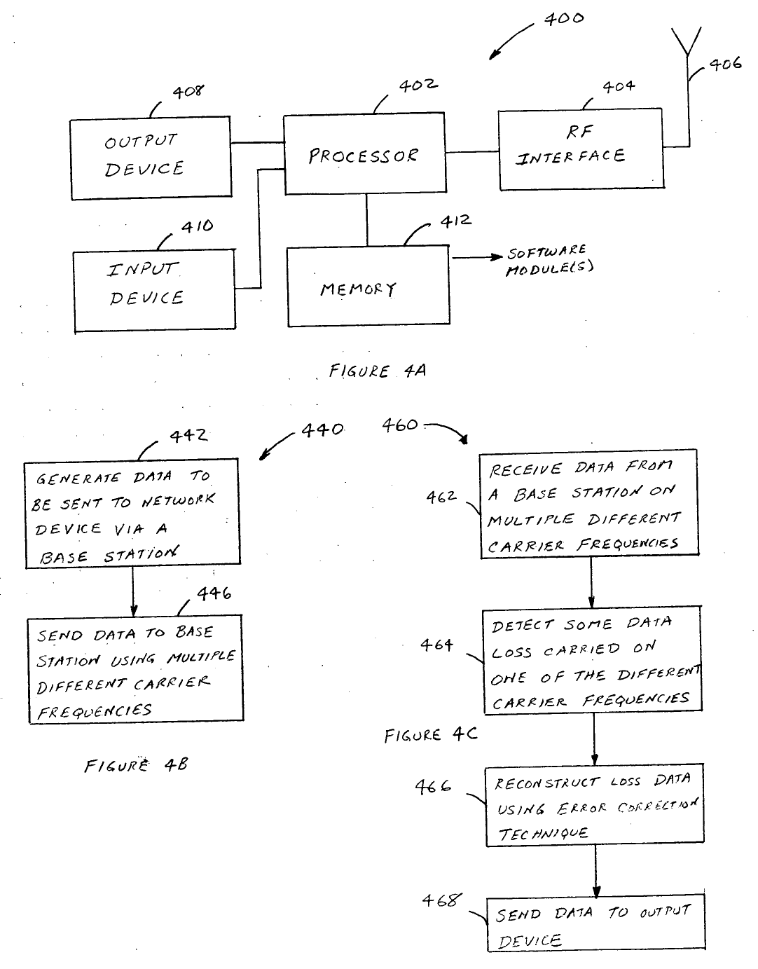

FIG. 4A illustrates a block diagram of an exemplary mobile communication unit (MU) 400 in accordance with another embodiment of the invention. The mobile communication unit (MU) 400 may be an exemplary detailed version of any one of the mobile communication units (MU) 211 through 214 of wireless communication system 200. In particular, the mobile communication unit (MU) 400 comprises a processor 402, an RF interface 404 and antenna 406, an output device 408, an input device 410, and a memory 412. The processor 402 assists in performing the various operations of the mobile communication unit (MU), two of which are described with reference to FIGS. 4B and 4C. The RF interface 404 and antenna 406 provide the processor 402 an interface to the wireless medium for communicating with base transceiver stations (BTS). The output device 408 (e.g., a display, speaker, vibrating unit) allows the processor 402 to send information to a user of the exemplary mobile communication unit (MU) 400. The input device 410 (e.g., keyboard, touch sensitive display, pointing device, microphone) allow a user to send information to the processor 402. And the memory 412, serving generally as a computer readable medium, stores one or more software module(s) for controlling the operations of the processor 402.

FIG. 4B illustrates a flow diagram of an exemplary method of transmitting data to a base transceiver station (BTS) in accordance with another embodiment of the invention According to the method 440, the processor 402 generates and/or receives data intended for the base transceiver station (BTS) (block 442). For example, the data may be voice data generated by the input device 410 and sent to the processor 402 for transmission to the base transceiver station (BTS). Or, the processor 402 may have generated the data pursuant to a software module(s) stored in the memory 412.

If the corresponding wireless communication system uses code division multiple access (CDMA), the processor 402 may modulate the data in a CDMA manner. Once the processor 402 has obtained the data and modulated in a CDMA manner, it sends the data to the RF interface 404 for transmission to the base transceiver station (BTS) (block 446). The RF interface 404 modulates the CDMA data onto multiple, different RF carriers, and then transmits the RF carriers to the base transceiver station (BTS) by way of the antenna 406.

FIG. 4C illustrates a flow diagram of an exemplary method 460 of receiving data from a base transceiver station (BTS) in accordance with another embodiment of the invention. According to the method 460, the processor 402 receives data from the base transceiver station (BTS) by way of the RF interface 404 and antenna 406 (block 462). The data received was originally modulated onto multiple, different RF carriers and subsequently demodulated by the RF interface 404. The processor 402 may then perform CDMA demodulation to obtain the raw data. In this example, the processor 402 detects that some data associated with at least one of the RF carriers has been lost (block 464). This may have been as a result of a poor RF environment for that particular RF carrier. The processor 402 then performs an error correction technique to recover the lost data (block 466). Once the lost data has been recovered, the processor 402 may send the data to the user by way of the output device 408 (block 468).

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A wireless communication system, comprising a base transceiver station (BTS) adapted to transmit first data to a mobile communication unit (MU) in a communication session by way of a first set of different frequency carriers.

2. The wireless communication system of claim 1, wherein the base transceiver station (BTS) is adapted to modulated the first data in a code division multiple access (CDMA) manner.

3. The wireless communication system of claim 1, further comprising a plurality of the base transceiver stations (BTS).

4. The wireless communication system of claim 1, further comprising a network, wherein the base transceiver station (BTS) is adapted to receive the first data from the network.

5. The wireless communication system of claim 1, wherein the base transceiver station (BTS) is further adapted to receive second data from the mobile communication unit (MU) in the communication session carried by a second set of different frequency carriers.

6. The wireless communication system of claim 5, wherein the base transceiver station (BTS) is adapted to:
detect a loss of some of said second data associated with at least one of the second set of different frequency carriers; and
attempt to recover the lost data.

7. The wireless communication system of claim 6, wherein the base transceiver station is adapted to recover the lost data using an error correction technique.

8. The wireless communication system of claim 5, wherein the base transceiver station (BTS) is adapted to rearrange the second data in a predetermined manner.

9. The wireless communication system of claim 5, wherein the base transceiver station (BTS) is adapted to perform code division multiple access (CDMA) demodulation to obtain the second data.

10. The wireless communication system of claim 5, further comprising a network, wherein the base transceiver station (BTS) is adapted to send the second data to the network.

11. A base transceiver station (BTS), comprising:
an antenna;
a processor adapted to generate and/or receive first data to send to a mobile communication unit (MU); and
a radio frequency (RF) interface adapted to modulate the first data onto a first set of different frequency carriers, and transmit the first set of different frequency carriers to the mobile communication unit (MU) by way of the antenna.

12. The base transceiver station (BTS) of claim 11, wherein the processor is further adapted to code division multiple access (CDMA) modulate the first data.

13. The base transceiver station (BTS) of claim 11, further comprising a network interface, wherein the processor is adapted to receive the first data from a network device by way of the network interface.

14. The base transceiver station (BTS) of claim 11, wherein the RF interface is further adapted to demodulate a second set of different frequency carriers received from the mobile communication unit (MU) in the communication session by way of the antenna to obtain second data, and send the second data to the processor.

15. The base transceiver station (BTS) of claim 14, wherein the processor is adapted to:
detect a loss of some of the second data associated with at least one of the second set of different frequency carriers; and
attempt to recover the lost second data.

16. The base transceiver station (BTS) of claim 15, wherein the processor is adapted to recover the lost second data using an error correction technique.

17. The base transceiver station (BTS) of claim 14, wherein the base transceiver station (BTS) is adapted to rearrange the second data in a predetermined manner.

18. The base transceiver station (BTS) of claim 14, wherein the processor is adapted to perform code division multiple access (CDMA) demodulation to obtain the second data.

19. The base transceiver station (BTS) of claim 14, further comprising a network interface, wherein the processor is adapted to send the second data to a network device by way of the network interface.

20. A wireless communication system, comprising a base transceiver station (BTS) adapted to receive data from a mobile communication unit (MU) in a communication session carried by a set of different frequency carriers.

21. The wireless communication system of claim 20, wherein the base transceiver station (BTS) is adapted to:
detect a loss of data associated with at least one of the set of different frequency carriers; and
attempt to recover the lost data.

22. The wireless communication system of claim 21, wherein the base transceiver station (BTS) is adapted to recover the lost data using an error correction technique.

23. The wireless communication system of claim 20, wherein the base transceiver station (BTS) is adapted to rearrange the data received from the mobile communication unit (MU) in a predetermined manner.

24. The wireless communication system of claim 20, wherein the base transceiver station (BTS) is adapted to perform code division multiple access (CDMA) demodulation to obtain the data received from the mobile communication unit (MU).

25. The wireless communication system of claim 20, further comprising a network, wherein the base transceiver station (BTS) is adapted to send the data received from the mobile communication unit (MU) to the network.

26. A base transceiver station (BTS), comprising:
an antenna;
a processor;
an RF interface adapted to:
demodulate a set of different frequency carriers received from a mobile communication unit (MU) during a communication session by way of the antenna to obtain data, and
send the data to the processor.

27. The base transceiver station (BTS) of claim 26, wherein the processor is adapted to:
detect a loss of some of the data associated with at least one of the set of different frequency carriers; and
attempt to recover the lost second data.

28. The base transceiver station (BTS) of claim 27, wherein the processor is adapted to recover the lost data using an error correction technique.

29. The base transceiver station (BTS) of claim 26, wherein the processor is adapted to rearrange the data in a predetermined manner.

30. The base transceiver station (BTS) of claim 26, wherein the processor is adapted to perform code division multiple access (CDMA) demodulation to obtain the data.

31. The base transceiver station (BTS) of claim 26, further comprising a network interface, wherein the processor is adapted to send the data to a network device by way of the network interface.

32. A mobile communication unit (MU), comprising:
an antenna;
a radio frequency (RF) interface adapted to demodulate a set of different frequency carriers received by way of the antenna to obtain data from a base transceiver station (BTS); and
a processor adapted to receive the data from the base transceiver station (BTS).

33. The mobile communication unit (MU) of claim 32, wherein the processor is adapted to:
detect a loss of data associated with at least one of the set of different frequency carriers; and
attempt to recover the lost data.

34. The mobile communication unit (MU) of claim 33, wherein the processor is adapted to recover the lost data using an error correction technique.

35. The mobile communication unit (MU) of claim 32, wherein the processor is adapted to rearrange the data received from the base transceiver station (BTS) in a predetermined order.

36. The mobile communication unit (MU) of claim 32, wherein the data received from the RF interface by the processor is code division multiple access (CDMA) modulated, and wherein the processor is adapted to perform a demodulation of the CDMA-modulated data.

37. The mobile communication unit (MU) of claim 32, further comprising an output device, wherein the processor is adapted to send the data to the output device.

38. A mobile communication unit (NU), comprising:
an antenna;
a processor adapted to generate and/or receive data for transmission to a base transceiver station (BTS);
a radio frequency (RF) interface adapted to modulate the data onto a set of different frequency carriers, and transmit the set of different frequency carriers to the base transceiver station (BTS) by way of the antenna.

39. The mobile communication unit (MU) of claim 38, wherein the processor is further adapted to code division multiple access (CDMA) modulate the data.

40. The mobile communication unit (MU) of claim 38, further comprising an input device adapted to generate and send the data to the processor.
